(19) United States
(12) Patent Application Publication
(10) Pub. No.: US 2008/0172493 A1
(43) Pub. Date: Jul. 17, 2008

(54) Method, system and host for telecommunications involving IPv4 and IPv6

(75) Inventors: Eric Gray, Lee, NH (US); Lowell Gilbert, Acton, MA (US)

Correspondence Address: Ansel M. Schwartz;Attorney at Law, Suite 304, 201 N. Craig Street, Pittsburgh, PA, 15213, US

(73) Assignee: Ericsson, Inc.

(21) Appl. No.: 11/652,318

(22) Filed: Jan. 11, 2007

(51) Int. Cl. G06F 15/16

(52) U.S. Cl. 709/230

(57) ABSTRACT

A host for a telecommunications system includes a container. The host includes an IPv4 stack disposed in the container. The host includes an IPv6 stack disposed in the container. The host includes a mapping layer disposed in the container in communication with the IPv4 stack and the IPv6 stack to map IPv4 addresses to IPv6 addresses. A telecommunications system includes an IPv6 transport network. The system includes an IPv4 transport network having IPv4 hosts. The system includes an host, in communication with the IPv6 transport network and the IPv4 transport network, having an IPv4 functionality layer for supporting IPv4 applications, and an IPv6 functionality layer for supporting IPv6 applications, and a mapping layer in communication with the IPv4 functionality layer in the IPv6 functionality layer for mapping IPv6 addresses and IPv4 addresses between the IPv4 hosts and IPv4 applications and the IPv6 transport network. A method for communicating.

### FIELD OF THE INVENTION

The present invention is related to a communications system that supports both IPv4 applications and IPv6 applications. More specifically, the present invention is related to a communications system that supports both IPv4 applications and IPv6 applications utilizing an intermediary host having a mapping layer in communication with an IPv4 functionality layer and an IPv6 functionality layer for mapping IPv6 addresses and IPv4 addresses between IPV4 hosts and IPv4 applications and an IPv6 transport network.

### BACKGROUND OF THE INVENTION

Existing computer applications most often assume the use of IPv4 addresses. One of the impediments to adopting IPv6 is the huge burden of porting/modifying applications to work with a new IP address format.

In a typical application that requires access to network resources, the application uses an operating system call to determine the address of the remote server, host or device. Having obtained this address, the application uses the local hosts networking facilities to exchange messages with one or more other network devices.

Applications, therefore, typically obtain, store and use this address. Previously, all such addresses were 32 bits (or 4 octets) long in the common networking technology “Internet Protocol (IP) version 4.”

With the advent of IPv6 and its much larger address format (128 bits or 16 octets), many of these applications might need to be re-written. Typically, each host will have literally hundreds of applications that may access the network in this way, and the cost of re-writing these applications is prohibitive. Most such applications are replaced by IPv6 supporting applications through obsolescence and attrition.

One current approach going forward to deal with the two different address formats and existing IPv4 applications is to characterize hosts as either IPv4 hosts, IPv6 hosts (with a subset of existing applications that have been modified for IPv6) and dual-stack hosts (hosts having both IPv6 and IPv4 network stacks).

One inter-working model for the IPv4 only hosts—and for the IPv4 only applications on dual-stack hosts—is to use an external Network Address Translation function to map IPv6 addresses and IPv4 addresses (back and forth) between the IPv4 hosts/applications and the IPv6 transport network.

This approach has a number of issues—in part relating to complexity of determining a consistent local-network visible mapping of IPv4<→IPv6 addresses.

The present invention defines a modification to the under-lying operating system—the mini-NAT function—to support existing applications as is. This invention provides a simple way to continue support of existing applications on any operating system or platform that current uses IPv4 and will eventually need to use IPv6.

### BRIEF SUMMARY OF THE INVENTION

The present invention pertains to a host for a telecommunications system. The host comprises a container. The intermediary host comprises an IPv4 stack disposed in the container. The host comprises an IPv6 stack disposed in the container. The host comprises a mapping layer disposed in the container in communication with the IPv4 stack and the IPv6 stack to map IPv4 addresses to IPv6 addresses.

The present invention pertains to a telecommunications system. The system comprises an IPv6 transport network. The system comprises an IPv4 transport network having IPv4 hosts. The system comprises a host, in communication with the IPv6 transport network and the IPv4 transport network, having an IPv4 functionality layer for supporting IPv4 applications, and an IPv6 functionality layer for supporting IPv6 applications, and a mapping layer in communication with the IPv4 functionality layer and the IPv6 functionality layer for mapping IPv6 addresses and IPv4 addresses between the IPv4 hosts and IPv4 applications and the IPv6 transport network so IPv4 applications will run in an IPv6 network.

The present invention pertains to a method for communicating. The method comprises the steps of supporting IPv4 applications with an IPv4 functionality layer of a host in communication with an IPv6 transport network and an IPv4 transport network. There is the step of supporting IPv6 applications with an IPv6 functionality layer of the host. There is the step of mapping IPv6 addresses and IPv4 addresses between IPv4 hosts of the IPv4 network and IPv4 applications and the IPv6 transport network with a mapping layer of the intermediary host in communication with the IPv4 functionality layer and the IPv6 functionality layer. There is the step of running the IPv4 applications in the IPv6 transport network.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a block diagram of an intermediary host of the present invention.

FIG. 2 is a block diagram of a system of the present invention.

FIG. 3 is a block diagram of a system of a host deployed in an IPv6 network.

FIG. 4 is a block diagram of a system of a host deployed in an IPv4 network.

FIG. 5 is a block diagram of a system of a host deployed in a merged (IPv6/v4) network.

### DETAILED DESCRIPTION OF THE INVENTION

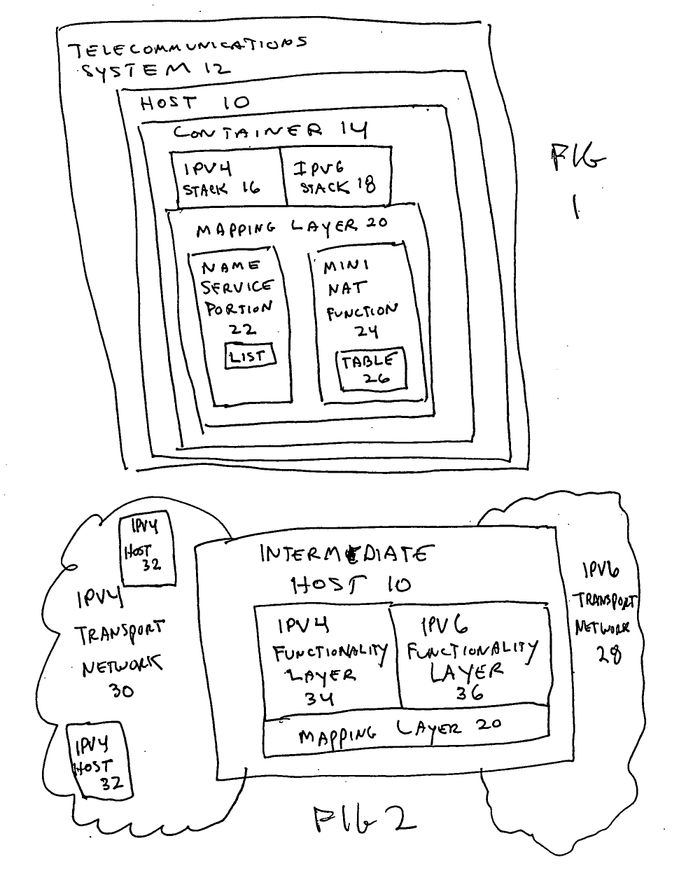

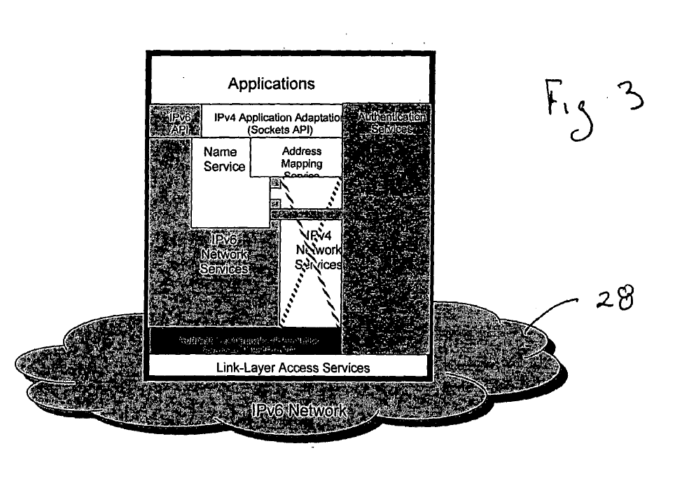

Referring now to the drawings wherein like reference numerals refer to similar or identical parts throughout the several views, and more specifically to FIG. 1 thereof, there is shown a host 10 for a telecommunications system 12. The host 10 comprises a container 14. The host 10 comprises an IPv4 stack 16 disposed in the container 14. The host 10 comprises an IPv6 stack 18 disposed in the container 14. The intermediary host 10 comprises a mapping layer 20 disposed in the container 14 in communication with the IPv4 stack 16 and the IPv6 stack 18 to map IPv4 addresses to IPv6 addresses.

The mapping layer preferably allows an IPv4 application to run in an IPv6 network. Preferably, the mapping layer 20 has a name service portion 22 which has a list of addresses of hosts 10 in the system 12. The mapping layer 20 preferably includes a mini-NAT function 24. Preferably, the mini-NAT function 24 has a mapping table 26 for mapping IPv4 addresses to IPv6 addresses.

The present invention pertains to a telecommunications system 12. The system 12 comprises an IPv6 transport network 28. The system 12 comprises an IPv4 transport network 30 having IPv4 hosts 32. The system 12 comprises a host 10, in communication with the IPv6 transport network 28 and the IPv4 transport network 30, having an IPv4 functionality layer 34 for supporting IPv4 applications, and an IPv6 functionality layer 36 for supporting IPv6 applications, and a mapping layer 20 in communication with the IPv4 functionality layer 34 in the IPv6 functionality layer 36 for mapping IPv6 addresses and IPv4 addresses between the IPv4 hosts 32 and IPv4 applications and the IPv6 transport network 28 so IPv4 applications will run in an IPv6 network.

The present invention pertains to a method for communicating. The method comprises the steps of supporting IPv4 applications with an IPv4 functionality layer 34 of a host 10 in communication with an IPv6 transport network 28 and an IPv4 transport network 30. There is the step of supporting IPv6 applications with an IPv6 functionality layer 36 of the intermediary host 10. There is the step of mapping IPv6 addresses and IPv4 addresses between IPv4 hosts 32 of the IPv4 network and IPv4 applications and the IPv6 transport network 28 with a mapping layer 20 of the host 10 in communication with the IPv4 functionality layer 34 and the IPv6 functionality layer 36. There is the step of running the IPv4 applications in the IPv6 transport network.

Preferably, the IPv4 functionality layer 34, the IPv6 functionality layer 36 and the mapping layer 20 disposed in a container 14. Preferably, the mapping step includes the step of mapping IPv4 addresses to IPv6 addresses with a mapping table 26.

In the operation of the invention, the apparatus incorporates the NAT functionality within the host 10 IP(v4) stack 16. This is identified as a mini-NAT function 24 within the IP stack.

When the host 10 application attempts to determine the IP address of a server (or other network device) and the host 10 is attached to an IPv6 network, a mini-NAT function 24 intercepts requests, forwards them to a name service (DNS, or Domain Name Service, for example), and captures the response. If the response is an IPv6 address, the mini-NAT function 24 creates a local mapping between that IPv6 address and any “local” IPv4 address it might select (from the 10 number local class A network space, for example). In any case, the mini-NAT function 24 returns an IPv4 address to the application, allowing the application to store and use this address.

When any application uses the IPv4 stack 16 to send messages to another network device, the mini-NAT function 24 does a look-up in its mapping table 26 and—if it finds that there is a mapping for the given IPv4 address to an IPv6 address—it performs an address translation and sends the message using the mapped IPv6 destination address and its own local IPv6 destination as a source address. If there is no such mapping, the mini-NAT function 24 simply forwards the message in native IPv4 format.

The function is a sub-set of NAT because there is only the one IPv4 stack 16—therefore, no port number translation is ever required. Also, because the translated address is entirely host 10 local, there is no need to negotiate or publish a mapping value. Each such host 10 may derive its own local address mappings independently using whatever approach is most convenient.

A relatively small number of applications actually include discovered addresses in messages at a layer higher than the network level and these applications may each have to be addressed as “a special case.” However, a very large number of applications stash the given address for convenience only and assign no special significance to it. Those applications directly benefit from this approach as no modification to the application is required.

Also, the mechanism for defining local addresses must be consistent with host 10 configuration parameters (such as application visible IPv4 addresses and network mask information) and must include mechanisms to avoid address collision between pseudo-IPv4 (or mini-NAT mapped) addresses and real local IPv4 addresses.

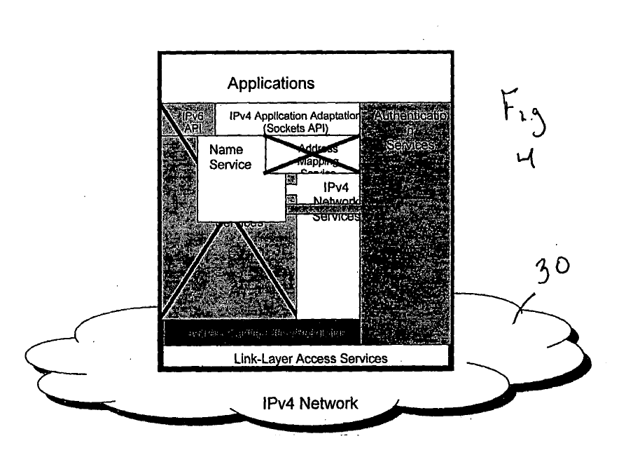

Referring to FIG. 3, in an IPv6 network 28, IPv4 network 30 services will not work, Address configuration and resolution services work only with IPv6 addresses, etc.

IPv6 applications work with the IPv6 API, through to the underlying IPv6 network 28 services (possibly including the name services to determine host 10/service name to address mapping) and the—from there—to link-layer access services (via Address Resolution services) and to the physical network.

IPv4 applications work with the IPv4 application adaptation (appears to the application as a standard IPv4 BSD Sockets API). The API provides an adaptation function mapping the underlying IPv6 services to IPv4 addresses: name services map host 10/service names to IPv6 addresses, which are stored in a local mapping table 26 and re-mapped to a host 10-local IPv4 address from the well-known private address space; subsequent socket API function calls (open) will specify the IPv4 address returned via name (re-mapping) services, and these IPv4 addresses are reverse-mapped to IPv6 addresses, establishing port-mappings as well (similar to network address translation or NAT); further socket calls (send, recv, etc.) refer to the socket “handle” (port number) and this is mapped directly to the appropriate IPv6 address; these same calls (send) then result in using the IPv6 network 28 services—and link-layer access services (via Address Resolution services) and to the physical network. Data received from the network is associated to a specific socket “handle” using the address (and port) mapping services (again in a fashion similar to NAT).

Some application services require end-to-end address transparency for authentication. In many cases, it is possible to use the internal IP stack (and address mapping services) to provide authentication independent of the application's explicit awareness of the local and remote host's actual/real addresses. For applications where this is not true, it will be necessary to (at least partially) port the application for IPv6.

Note: the existence of the IPv6 API is required only to the extent that there may be IPv6 applications which perform sub-optimally using IPv4. Since IPv6 compatible applications typically are backward compatible with IPv4 networks 30, it should be possible to omit the higher layer portions of the IPv6 stack 18, including the IPv6 (sockets) API, and use the IPv4 application adaptation for all applications.

Because the underlying network is an IPv6 network 28, the IPv4 network 30 services are effectively disabled.

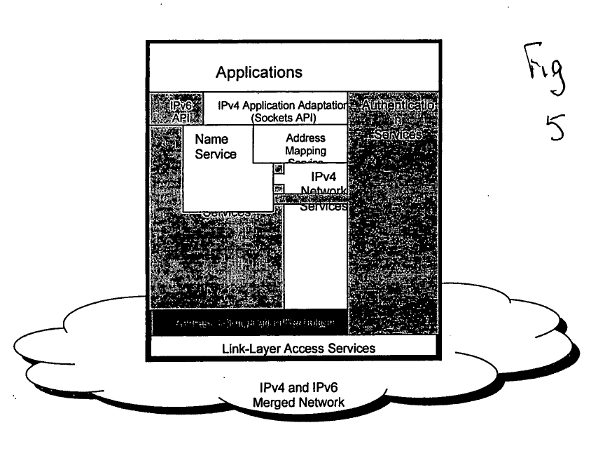

Referring to FIG. 4, with the host 10 deployed in an IPv4 network 30, the name service always returns IPv4 addresses, hence the address mapping services are never invoked and are—consequently—effectively disabled.

Because the underlying network in this case is an IPv4 network 30, the IPv6 network 28 services are effectively disabled.

Because IPv6 applications typically are backward compatible with IPv4 networks 30, the higher layer portions of the IPv6 stack 18, including the IPv6 (sockets) API, are also effectively disabled. The IPv4 application adaptation—which (because of the fact that mapping does not occur) is effectively a standard IPv4 (sockets) API—is used for all applications.

Referring to FIG. 5, in a mixed network (where some hosts/services are IPv6 and others are IPv4), the local host 10 will obtain both an IPv4 and IPv6 local address by whatever methods are in use on that network. Name services may return either an IPv4 or an IPv6 address for any specific host 10/service. The intention would be that both IPv6 and IPv4 applications could operate in a so-called ships-in-the-night mode in such a network.

An alternative for a host 10 on this type of network is described here. An existing (IPv4 only) application may use the adaptation (and address mapping) services to map an IPv6 host 10/service address to an IPv4 address in exactly the same way that it could do so in an IPv6 only network. Again, it may be possible to omit the IPv6 (sockets) API for any given host 10.

One additional complication may exist in this scheme. It is possible that an IPv4 address returned by the name service may collide with an IPv4 address allocated by the address mapping service and returned to specific applications. This would most likely result in confusing the applications conducting separate interactions with different hosts/services apparently using the same address.

To avoid this problem, the name service interacts with the address mapping service in two ways:
1) it checks that a returned IPv4 address is not already allocated in the mapping table 26 (if this has occurred, then an address collision has occurred and it is necessary to perform an IPv4-to-IPv4 address re-mapping) and
2) it depletes the IPv4 addresses available to the address mapping service (thus preventing a future address collision).

There are additional steps which can be taken to further reduce the already unlikely occurrence of this problem. For example, the private address space used by the address mapping service may be either manually configurable, or may “auto-configure” based on IP address (and network mask) information configured via the address configuration services.

Note also that other address ranges may be selected/configured in lieu of the “private address” space—further reducing the probability of address collisions.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A host for a telecommunications system comprising:
a container;
an IPv4 stack disposed in the container;
an IPv6 stack disposed in the container; and
a mapping layer disposed in the container in communication with the IPv4 stack and the IPv6 stack to map IPv4 addresses to IPv6 addresses.

2. A host as described in claim 1 wherein the mapping layer allows an IPv4 application to run in an IPv6 network.

3. A host as described in claim 2 wherein the mapping layer has a name service portion which has a list of addresses of hosts in the system.

4. A host as described in claim 3 wherein the mapping layer includes a mini-NAT function.

5. A host as described in claim 4 wherein the mini-NAT function has a mapping table for mapping IPv4 addresses to IPv6 addresses.

6. A telecommunications system comprising:
an IPv6 transport network;
an IPv4 transport network having IPv4 hosts; and
a host, in communication with the IPv6 transport network and the IPV4 transport network, having an IPv4 functionality layer for supporting IPv4 applications, and an IPv6 functionality layer for supporting IPv6 applications, and a mapping layer in communication with the IPv4 functionality layer and the IPv6 functionality layer for mapping IPv6 addresses and IPv4 addresses between the IPv4 hosts and IPv4 applications and the IPv6 transport network so IPv4 applications will run in an IPv6 network.

7. A method for communicating comprising the steps of:
supporting IPv4 applications with an IPv4 functionality layer of a host in communication with an IPv6 transport network and an IPv4 transport network;
supporting IPv6 applications with an IPv6 functionality layer of the host;
mapping IPv6 addresses and IPv4 addresses between IPv4 hosts of the IPv4 network and IPv4 applications and the IPv6 transport network with a mapping layer of the host in communication with the IPv4 functionality layer and the IPv6 functionality layer; and
running the IPv4 applications in the IPv6 transport network.

8. A method as described in claim 7 wherein the mapping step includes the step of mapping IPv4 addresses to IPv6 addresses with a mapping table.
